(19) United States
(12) Patent Application Publication
(10) Pub. No.: US 2007/0131249 A1
(43) Pub. Date: Jun. 14, 2007

(54) Probe washing method of scanning probe microscope

(76) Inventor: Takuya Nakaue, Chiba-shi (JP)

Correspondence Address: BRINKS HOFER GILSON & LIONE, P.O. BOX 10395, CHICAGO, IL, 60610, US

(21) Appl. No.: 11/633,333

(22) Filed: Dec. 4, 2006

(30) Foreign Application Priority Data
Dec. 9, 2005 (JP) JP2005-355735

(51) Int. Cl. B08B 3/12; B08B 7/00; B08B 6/00

(52) U.S. Cl. 134/6; 134/42; 134/1

(57) ABSTRACT

A probe to which a foreign matter has adhered is pressed to a sample. At this time, between a scanner in a cantilever side and a sample base, there are relatively generated a horizontal oscillation and a vertical oscillation. By generating a suitable friction to the probe tip, the foreign matter having adhered to the tip of the probe is removed, and it can be washed.

This application claims priority under 35 U.S.C. §119 to Japanese Patent Application No. JP2005-355735 filed Dec. 9, 2005, the entire content of which is hereby incorporated by reference.

### BACKGROUND OF THE INVENTION

The present invention relates to a method of removing and moving a matter having adhered to a probe tip of a scanning probe microscope (SPM) obtaining, by a probe, an information of a measurement sample by relatively scanning the measurement sample.

As well known, as an apparatus for performing an observation of a surface shape of the sample and a measurement of a physical property information and the like by measuring the sample of an electronic material and the like in a micro-region, there is used the scanning probe microscope (SPM).

As the scanning probe microscope, although various types are provided, in one among them, there is a method of performing the observation of a sample surface by using the probe having been provided in a tip of a cantilever (See G. Binning, C. F. Quate, and Ch. Gerber, Phys. Rev. Lett. 56, 930 (1986)).

However, in the conventional scanning probe microscope having been mentioned above, in a case where the sample in whose surface there exists a large amount of foreign matter, there is the fact that the foreign matter adheres to the probe tip and thus it becomes impossible to perform an accurate shape measurement. Further, although there is also a method of performing a working of the sample by the probe, there has been a problem that, if the foreign matter is adhered, the working becomes impossible to be performed (See T. Amano, M. Nishiguchi, H. Hashimoto, Y. Morikawa, N. Hayashi, R. White, R. Bozak, and L. Terril, Proc. of SPIE 5256 538-545 (2003)).

Problems of the invention are to solve the above issue, to perform the removal of the foreign matter having adhered to the probe to thereby make it possible to utilize the probe again and, in a case where the probe is used for the working, to make it possible to perform a stable working by removing the foreign matter having adhered to the probe. Additionally, it is the problem to wash the probe tip in an inside of an SPM apparatus having been used for the observation or the working, without using other vacuum device and the like in order to wash the probe.

### SUMMARY OF THE INVENTION

In order to solve the above problems, in a probe washing method of a scanning probe microscope according to the invention, firstly, there is removed a matter, which has adhered to a probe when observing or working a sample, by relatively oscillating the probe while being pressed to a non-observed or non-worked portion of the sample.

Secondly, the oscillation is performed in a horizontal direction and a vertical direction.

Thirdly, an oscillation width of the oscillation in the horizontal direction is made 100 nm or less, and an oscillation width of the oscillation in the vertical direction 1 μm or less.

Fourthly, there is removed a matter, which has adhered to a probe when observing or working a sample, by relatively oscillating the probe while being pressed to a member having been made of a matter softer than the probe.

Fifthly, the probe is made diamond in its material, and the soft matter is made a soft metal.

Sixthly, the soft matter is made a resin.

Seventhly, the soft matter has been made an electrically conductive matter.

(Actions)

By removing the matter, which has adhered to the probe when observing or working the sample, by relatively oscillating the probe while being pressed to the non-observed or non-worked portion of the sample, it is possible to efficiently generate a friction. By causing the foreign matter having adhered to the probe to escape to the sample by a heat and a physical force, which are generated by this friction, it is possible to perform a foreign matter removal of the probe tip.

By simultaneously generating the vertical oscillation and the horizontal oscillation, the foreign matter having adhered to the probe tip strongly contacts with the sample, so that it is possible to efficiently remove the foreign matter.

By the fact that the oscillation width of the oscillation in the horizontal direction is made 100 nm or less, i.e., a horizontal oscillation amplitude is made the same as a general probe tip diameter or less than it, a progress in an abrasion of a probe tip portion is suppressed.

By enlarging the oscillation width of the oscillation in the vertical direction, i.e., a vertical oscillation width, till 200 nm—about him to thereby increase the friction, the foreign matter removal is efficiently performed. Even if the vertical oscillation width is enlarged, a degree of the abrasion in the probe tip diameter does not so advance in comparison with enlarging a horizontal oscillation width.

By removing the matter, which has adhered to the probe when observing or working the sample, by relatively oscillating the probe while being pressed to the member having been made of the matter softer than the probe, it can be more efficiently removed. That is, by causing the probe to contact strongly with the sample softer than the probe and, under this state, exerting the oscillation in the horizontal and vertical directions, in a case where the foreign matter has adhered to the probe, the foreign matter having been nipped between the probe and the sample escapes to the sample by a frictional heat having been generated by the oscillation and the physical force due to the oscillation and, by this, it is possible to remove the foreign matter in the probe tip.

By using an electrically conductive sample, a static electricity having generated in an AFM or SPM probe tip can be removed till a portion of several nm—μm from the probe tip. A range in which the static electricity can be removed depends on a pressing depth and the vertical oscillation width of the probe when the probe has been contacted.

According to the invention, the probe can be utilized again by performing the removal of the foreign matter having adhered to the probe and, further in a case where the probe is used in the working, a stable working is performed by removing the foreign matter having adhered to the probe. Additionally, it is possible to wash the probe tip in the inside of the SPM apparatus having been used for the observation or the working, without using other vacuum device and the like in order to wash the probe.

### BRIEF DESCRIPTION OF THE DRAWINGS

FIG. 1 is a schematic view showing a washing of a probe tip in a scanning probe apparatus, according to the invention.

FIG. 2 is a photograph of the probe tip before a foreign matter removal in the invention.

FIG. 3 is a photograph of the probe tip after the foreign matter removal in the invention.

### DETAILED DESCRIPTION OF THE PREFERRED EMBODIMENTS

About an embodiment of the invention, there is explained below by referring to the drawings.

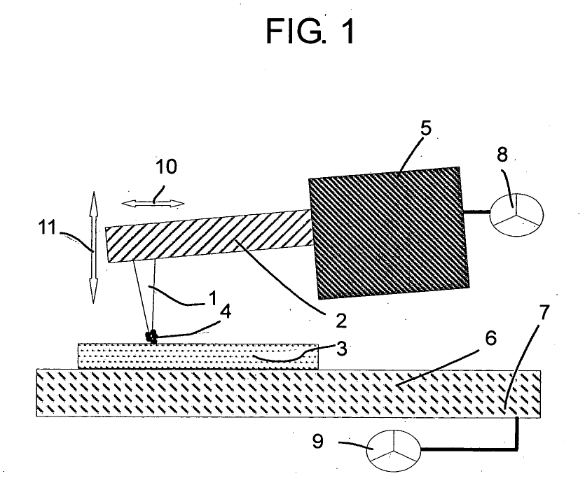

FIG. 1 is a schematic view when performing a removal of the foreign matter of an SPM probe tip in the invention. Generally, in a case where there is performed the observation of the sample surface by the probe of the SPM and the like, it is almost that in the sample surface there is the foreign matter of nm—micron size, or visible mm size. In a case where the sample in which the foreign matter exists is observed, there is the fact that the foreign matter adheres to the observing probe. Further, in a case where the sample is worked by the SPM probe, a working scrap of the sample adheres to the probe. If the foreign matter like this adheres to the probe, there is the fact that, by the SPM, it becomes impossible to perform a normal image observation. Thereupon, a foreign matter removal example of the probe tip according to the invention is shown in FIG. 1.

In FIG. 1, a probe 1 to which a foreign matter 4 has adhered is contacted with and pressed to a sample 3. Under this state, a horizontal oscillation 10 and a vertical oscillation 11 are simultaneously exerted. As to a mechanism of the oscillation, there are a method of oscillating a cantilever 2 or oscillating the sample 3, and a method of combining the both. Concretely, there are installed a scanner 5, in a cantilever side, supporting the cantilever, and an oscillator 9 capable of generating the oscillation in a sample base 6 fixing the sample 3. The horizontal and vertical oscillations are generated by any of the scanner 5 in the cantilever side, an oscillator 8 in the cantilever side, a scanner 7 in a sample base side and the oscillator 9 in a sample base side, and they may be generated by combining the formers. Here, by an intensity by which the probe 1 is pressed to the sample and an amplitude quantity of the vertical oscillation 11, there is determined a removal possible range of the foreign matter 4 having adhered to the probe 1. Additionally, by exerting the horizontal oscillation 10, the foreign matter 4 more strongly contacts with the sample 3, so that it is possible to efficiently remove the foreign matter 4 having adhered to the probe 1.

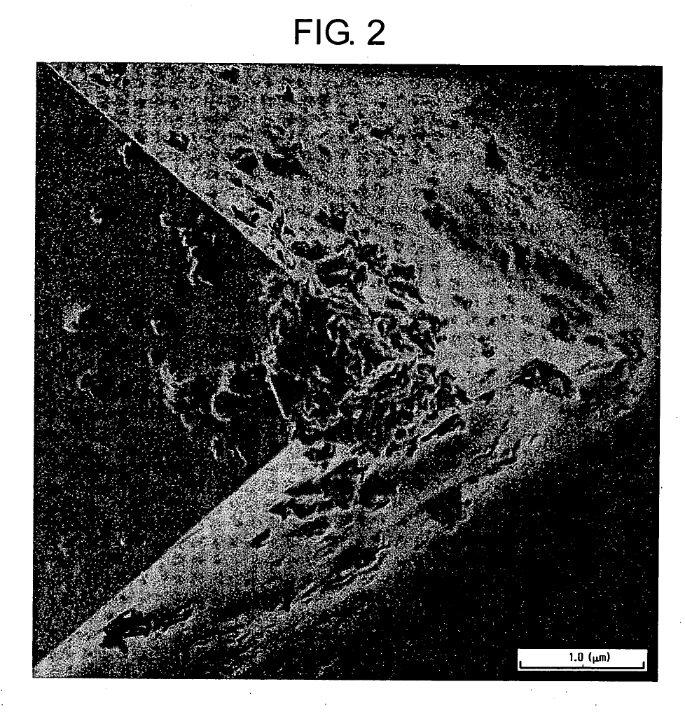

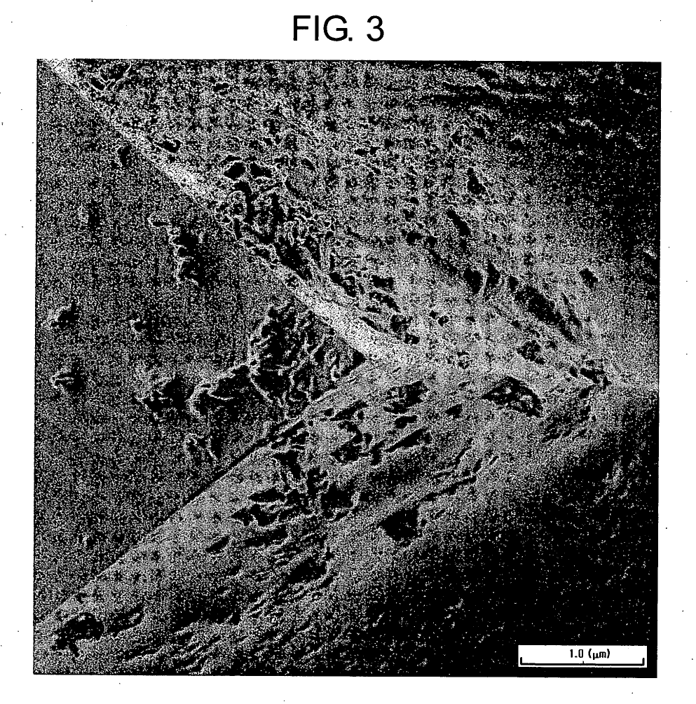

As a concrete example, there is mentioned about a case where diamond has been used in the probe 1, and copper in the sample 3. FIG. 2 is a photograph of a tip of a diamond probe after the foreign matter has adhered. This probe 1 is pressed to the sample 3 consisting of a copper plate. Under this state, when the removal has been implemented for five seconds at 500 Hz in the vertical oscillation 11,200 nm in a vertical oscillation amplitude, 10 Hz in the horizontal oscillation 10 and 15 nm in a horizontal oscillation amplitude, there has become like a photograph shown in FIG. 3. It has been possible to perform a washing of the probe for about 700 nm from a diamond tip. At this time, simultaneously it has been possible to cause the foreign matter to adhere to a specified place of the copper. Additionally, it has been also possible to remove a static electricity in the probe tip.

What is claimed is:

1. A probe washing method of a scanning probe microscope, removing a matter, which has adhered to a probe when observing or working a sample, by relatively oscillating the probe while being pressed to a non-observed or non-worked portion of the sample.

2. A probe washing method of a scanning probe microscope according to claim 1, wherein the oscillation is performed in a horizontal direction and a vertical direction.

3. A probe washing method of a scanning probe microscope according to claim 2, wherein an oscillation width of the oscillation in the horizontal direction is 100 nm or less, and an oscillation width of the oscillation in the vertical direction 1 μm or less.

4. A probe washing method of a scanning probe microscope, removing a matter, which has adhered to a probe when observing or working a sample, by relatively oscillating the probe while being pressed to a member having been made of a matter softer than the probe.

5. A probe washing method of a scanning probe microscope according to claim 4, wherein the probe is diamond in its material, and the soft matter is a soft metal.

6. A probe washing method of a scanning probe microscope according to claim 4, wherein the soft matter is a resin.

7. A probe washing method of a scanning probe microscope according to claim 4, wherein the soft matter is an electrically conductive matter.
